(19) United States
(12) Patent Application Publication
(10) Pub. No.: US 2014/0114747 A1
(43) Pub. Date: Apr. 24, 2014

(54) METHODS AND SYSTEMS FOR ANALYZING CHANGES IN AGGREGATE RATIO METRICS

(71) Applicant: Google Inc., Mountain View, CA (US)

(72) Inventors: Christopher Park Mah, Mountain View, CA (US); William Dennis Kunz, Mountain View, CA (US)

(73) Assignee: Google Inc., Mountain View, CA (US)

(21) Appl. No.: 13/657,564

(22) Filed: Oct. 22, 2012

(51) Int. Cl. G06Q 30/02

(52) U.S. Cl. 705/14.45; 705/14.41

(57) ABSTRACT

Methods, systems, and apparatus for analyzing aggregate ratio metric changes are provided. The method includes storing a plurality of metrics in a memory device, identifying a first measurement of a ratio metric for a first time period and a second measurement of the ratio metric for a second time period from the plurality of metrics stored in the memory device, wherein a change has occurred in the ratio metric between the first time period and the second time period, identifying at least one component associated with the change, determining, using a computer device, at least one component vector corresponding to the at least one component, using the computer device to convert each of the at least one component vectors into a scalar, and identifying a percentage of change for each of the scalars.

### BACKGROUND OF THE INVENTION

This specification relates to online advertising and, more particularly, to methods and systems for analyzing advertising metrics expressed as ratios. However, the application of the methods and systems for analyzing changes in aggregate ratio metrics can be generally applied to any analysis that involves aggregate ratio metrics, such as analyzing and understanding the contributions of state GDP changes on the aggregate National GDP movements.

Analyzing changes in metrics is important in today's business world. Various types of businesses need to be able to measure and analyze changes in certain metrics including aggregate ratio metrics. At least one type of business that analyzes changes in aggregate ratio metrics is the business of providing online content. For example, one type of online content provider that analyzes such data is an online advertiser. Known online advertising systems enable advertisers to place advertisements, or ads, based on one or more dimensions, such as region, language, URL, search query strings, time of day, etc. On the other side of the advertising spectrum are publishers, like Google, Yahoo, AOL, etc. that will place advertiser's ads on their sites in exchange for collecting revenue advertisers. While it is useful to look at “one-dimensional” metrics such as revenue, queries, ad impressions, etc. to assess the effectiveness of a campaign or advertising platform, these one-dimensional metrics are of limited use when attempting to compare the relative performance among their advertising campaigns or their properties. To facilitate a better comparison, advertisers and publishers often rely on ratios to better understand and compare performance.

In addition to providing granularity to how ads are displayed, known online advertising systems measure and collect data on metrics like revenue per thousand queries (revenue per mille, or RPM), cost per click (CPC), clicks per query (click-through rate, or CTR), cost per acquisition (CPA), conversion rate (CvR), conversions per dollar (CPD), queries with ads shown versus overall queries (coverage), and others. Each of these metrics is a ratio of two metrics, which are referred to herein as “ratio” metrics or “two-dimensional” metrics, indicative of the property that these metrics are derived from a ratio of two metrics. Advertisers and publishers are often concerned with fluctuations in metrics, particularly CPA and RPM.

Changes to metrics can occur for a variety of reasons, and isolating the reason can be very difficult to do in a timely manner, particularly when those metrics are comprised of many components with different weights, e.g., traffic from different countries. A common issue that an advertiser or a publisher faces is a drop in RPM, CPA, or other ratio metric when Simpson's Paradox applies. Simpson's Paradox makes identifying the cause of a drop in RPM difficult because, under the Paradox, every component of the RPM metric may rise while the overall, or aggregate, RPM may fall due to the relative change in weights. The issue is further complicated when metrics, like RPM, are ratios. Accordingly, there is a need for methods and systems that enable identification of the biggest contributors to a change in a ratio metric.

### BRIEF DESCRIPTION OF THE INVENTION

In one embodiment, a computer-implemented method for analyzing changes in aggregate ratio metrics using a computer device coupled to a memory device is provided. The method includes storing a plurality of metrics in the memory device, identifying a first measurement of a ratio metric for a first time period and a second measurement of the ratio metric for a second time period from the plurality of metrics stored in the memory device wherein a change has occurred in the ratio metric between the first time period and the second time period, identifying at least one component associated with the change, determining, using the computer device, at least one component vector in two-dimensional space corresponding to the at least one component, using the computer device to convert each of the at least one component vectors into a scalar, and identifying a percentage of change for each of the scalars.

In another embodiment, a computer program product tangibly embodied in a non-transitory computer-readable storage device is provided. The computer program product includes instructions that, when executed by a processor, cause the processor to identify a first measurement of a ratio metric for a first time period and a second measurement of the ratio metric for a second time period from a plurality of metrics stored in a memory device wherein a change has occurred in the ratio metric between the first time period and the second time period, identify at least one component associated with the change, determine at least one component vector in two-dimensional space corresponding to the at least one component, convert each of the at least one component vectors into a scalar, and identify a percentage of change for each of the scalars.

In yet another embodiment, a computer system is provided. The computer system includes instructions stored on a non-transitory computer-readable medium and executable by at least one processor. The computer system includes a data retrieval engine for retrieving metric data from an ad metric datastore and an analysis engine. The analysis engine is for identifying, using metric data from said data retrieval engine, a first measurement of a ratio metric for a first time period and a second measurement of the ratio metric for a second time period wherein a change has occurred in the ratio metric between the first time period and the second time period, identifying at least one component associated with the change, determining at least one component vector in two-dimensional space corresponding to the at least one component, converting each of the at least one component vectors into a scalar, and identifying a percentage of change for each of the scalars.

### BRIEF DESCRIPTION OF THE DRAWINGS

FIGS. 1-5 show exemplary embodiments of the methods and systems described herein.

FIG. 1 is a block diagram illustrating an example environment for analyzing ratio metrics.

FIG. 2 is a block diagram illustrating an exemplary system for use with the environment in FIG. 1.

FIG. 3A is a screenshot of an exemplary dashboard for use with the system in FIG. 2.

FIG. 3B is an alternative screenshot of the exemplary dashboard shown in FIG. 3A.

FIG. 4 is a flow chart of an exemplary method for analyzing ratio metrics using the system in FIG. 2.

FIG. 5 is a block diagram illustrating a representative computing device that may be used to implement the systems of FIGS. 1 and 2.

Like reference numbers and designations in the various drawings indicate like elements.

### DETAILED DESCRIPTION OF THE INVENTION

Embodiments of the methods and systems described herein enable an analysis system to identify the percentage contribution, or percentage of change, of components of a ratio metric. A ratio metric is a metric that is two-dimensional or has a numerator and a denominator. More particularly, the analysis system is configured to retrieve ad metric data and identify an aggregate, or overall, change in a ratio metric, such as revenue per mille (RPM). The analysis system identifies two or more components of the ratio metric and identifies the percentage of change of each component. The percentage of change is distinguished from the percentage change. The percentage of change is the contribution of each component to the aggregate change. The percentage change of each component does not necessarily correlate to a component's contribution to an overall change. However, the percentage of change helps identify the component(s) that contributed most to the change in the ratio metric. The analysis system identifies percentages of change for components of ratio metrics by reducing the analysis problem from a two-dimensional problem to a one-dimensional problem.

The following detailed description illustrates embodiments of the invention by way of example and not by way of limitation. It is contemplated that the invention has general application to processing web traffic regardless of the type of webserver, how the traffic reaches the webserver, and/or the type of content provided by the webserver. It is also particularly applicable for many financial ratios, such as calculating contributory effects to changes on return on equity (ROE), profit margin, inventory turnover, a portfolio's earning's per share (EPS), and so forth. This method can be also be used in understanding contributing changes geopolitical ratios such as gross domestic product (GDP), mortality rate, education rate, health spend per capita, and so forth. In general, this method applies any time a system seeks to understand the contribution a particular component has on the effect of a ratio.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least one of: a) identifying a first measurement of a ratio metric for a first time period and a second measurement of the ratio metric for a second time period, wherein a change has occurred in the ratio metric between the first time period and the second time period; b) identifying at least one component associated with the change; c) identifying at least one component vector corresponding to the at least one component; d) converting each of the at least one component vectors into a scalar; and e) identifying a percentage of change for each of the scalars.

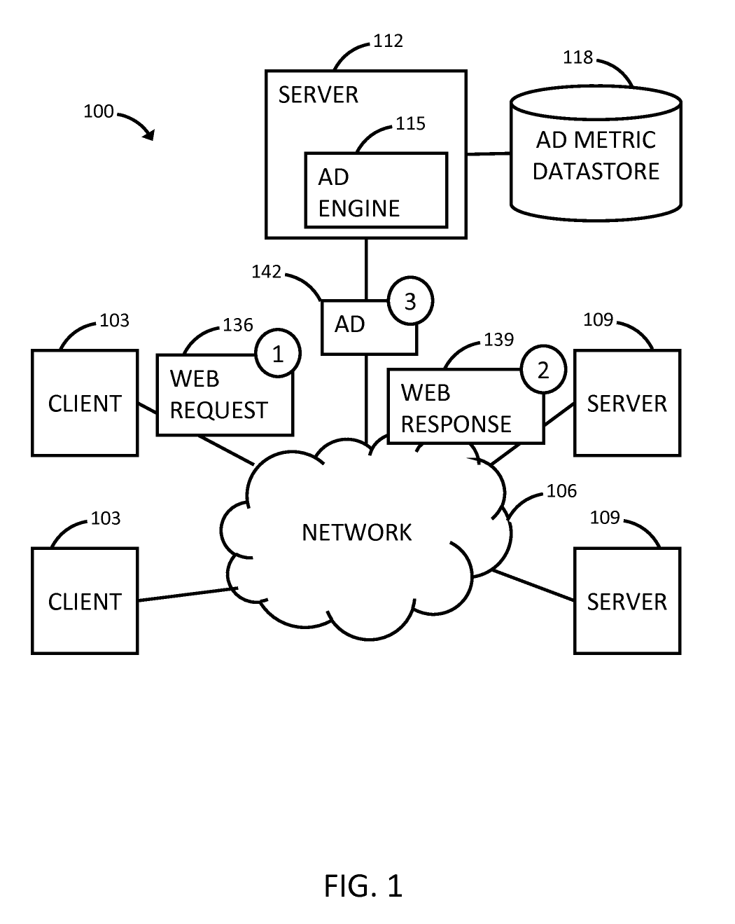

FIG. 1 is a diagram of an example environment 100 for analyzing ratio metrics. Environment 100 includes clients 103, or user devices, (e.g., from which web requests are generated) that are communicatively connected, through a network 106, with one or more servers 109 (e.g., webservers that respond to web requests from clients 103). In practice, there may be more or fewer clients 103 and/or servers 109. The clients 103, for example, can be used by users who access online resources, such as websites and webpages that are provided by server 109. The clients 103 can include web browsers (e.g., by which users can access the resources). The network 106 can include any combination of the Internet, local area networks (LANs), wide area networks (WANs), and other networks. Environment 100 includes a server 112 that is similar to server 109 and that includes an ad engine 115. Ad engine 115 delivers, serves, transfers, coordinates, and/or otherwise makes advertising available to clients 103 in response to web requests, whether those web requests are directed at server 112 and/or servers 109. Ad engine 115 is capable of monitoring which ads are sent to clients 103 and how clients 103 interact with the ads, e.g., whether an ad is clicked. Ad engine 115 stores data about ads and client interaction therewith in an ad metric datastore 118.

When an ad is served, one or more parameters may be used to describe how, when, and/or where the ad was served. These parameters are referred to as “dimensions” herein. Dimensions may include, for example, one or more of the following: features of (including information on) a document on which, or with which, the ad was served, a tag associated with the ad (e.g., a channel designated by the advertiser, which is an online advertising channel), a search query or search results associated with the serving of the ad, a user characteristic (e.g., their geographic location, city, region, country, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Dimensions may additionally include any other parameter about client 103, server 109, server 112, and/or the ad measurable and/or recordable by ad engine 115. Dimensions are stored in ad metric datastore 118. The term “dimension” should be not confused with the dimensionality of metrics, i.e., whether a metric is one- or two-dimensional.

Metrics relating to the usage of an ad are also stored in ad metric datastore 118. Some metrics are one-dimensional, or scalar, like a number of impressions. Other metrics are two-dimensional, or ratios. Ratios may include, but are not limited to, revenue per mille/thousand (RPM), cost per action (CPA), cost per click (CPC), cost per lead (CPL), cost per mille/thousand impressions (CPM), cost per sale (CPS), conversion rate, click through rate (CTR), coverage (i.e., queries with ads shown versus overall queries), etc. Ratio metrics may be calculated from two or more metrics.

The phrase “web request” includes more than just HTTP/HTTPS requests. For example, web requests may include requests to join a network, DNS requests, and/or any request for access, authentication, data, action, and/or response, communicated using any protocol. Accordingly, responses to web requests may include web content and/or any other appropriate response based on the content of the web request and the protocol used. Though HTTP-based web requests and HTML-based responses are used throughout, it is contemplated that ad engine 115 may be used with a variety of protocols, requests, responses not limited to just webpages and web content.

In one example flow of FIG. 1, a web request 136 is generated by a user using client 103 (stage 1). Generally, the web request 136 is formed by a web browser executing on client 103; however, the web request 136 may be formed by any software executing on client 103 and/or by any hardware component of client 103. The web request 136 includes a request for a web resource, such as a web page, that is accessible via a URL. The web request 136 is routed via the network 106 to server 109, which is associated with the requested web resource.

In response to the web request 136, a web response 139 and an ad 142 are provided to client 103 (stage 2 and 3). The web response 139 includes a web page, e.g., in HTML. Ad 142 may include graphics, sound, video, interactive elements, HTML, and/or text. Ad 142 may further include code executable by client 103 for use in interacting with a user of client 103. For example, and without limiting the generality of the foregoing, the ad 142 may be implemented using JavaScript that is executed by the web browser on client 103. In the exemplary embodiment, the web response 139 instructs client 103 to request the ad 142 from server 112, e.g., using an appropriate HTML tag. In some embodiments, the ad 142 is included in the web response 139 provided by the server 109.

Client 103 may provide data about client 103 for collection by ad engine 115. Collected data may include, but are not limited to, web browser type, web browser version, web browser language settings, user device screen size, user device Ethernet MAC address, user device CPU profile, user device network connection type, user device network connection speed, user device web browser cookies, HTTP reference, user device user agent string, and the like. Collected data may be stored in ad metric datastore 118 and associated with an ad served to client 103.

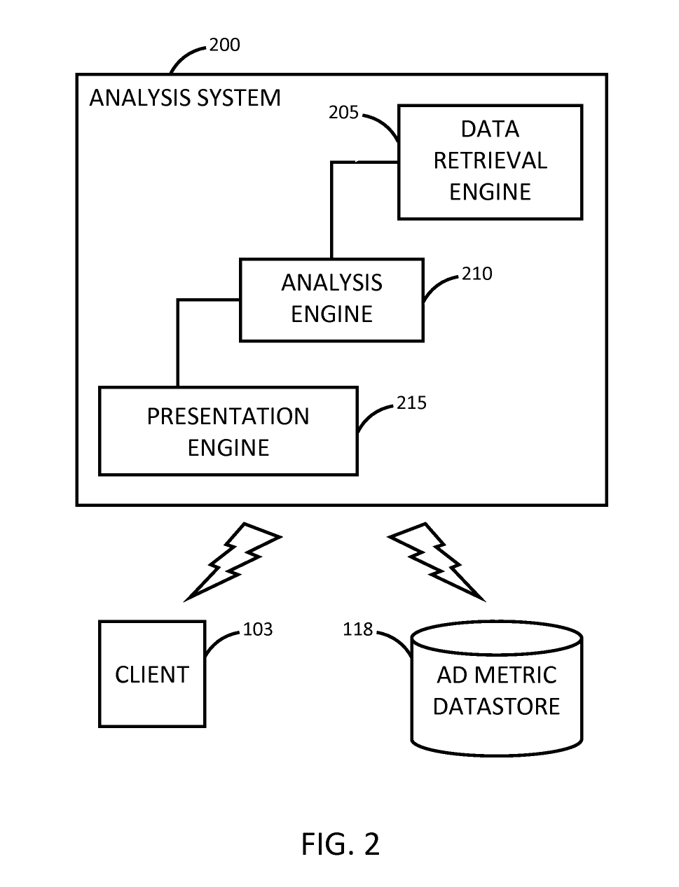

FIG. 2 is a block diagram of an exemplary analysis system 200 for use with environment 100 (shown in FIG. 1). More particularly, analysis system 200 is communicatively coupled to ad metric datastore 118 and client 103, e.g., via network 106 or otherwise. Analysis system 200 includes a data retrieval engine 205, an analysis engine 210, and a presentation engine 215. Data retrieval engine 205 is configured to retrieve data, i.e., at the request of analysis engine 210, from ad metric datastore 118.

Analysis engine 210 is configured to receive data from data retrieval engine 205, manipulate the data, and present the manipulated data using presentation engine 215. More particularly, and as discussed in more detail herein, analysis engine 210 facilitates identifying a percentage of change of each component of a ratio metric. Analysis engine 210 may reduce two-dimensional metrics into a single-dimensional metric by processing the two-dimensional metrics like vectors. A single-dimensional metric that has changed over time can be analyzed to determine the percentage impact the components of that metric contributed to the change. Table 1 illustrates, as an example, a single-dimensional metric, revenue, and two components, US and Canada.

TABLE 1

| Revenue | Start | Finish | % change | % of change |
|---|---|---|---|---|
| Overall | $1,000 | $1,200 | 20% | N/A |
| US | $800 | $900 | 12.5% | 50% |
| Canada | $200 | $300 | 50% | 50% |

For revenue (shown in Table 1), which is a single-dimensional metric, it is easy to see that both the US and Canada were equally responsible for the total increase in overall revenue. Both the US and Canada shared 50% of the change effect even though the actual percentage change for the US revenue was only one-fourth the percentage change of revenue in Canada. The “percent change” is a measure of how the observed metric changed for a particular component. The “percentage of change” is a quantification of how much the component moved the overall change in the observed metric. As the percentage of change is difficult to calculate for two-dimensional metrics, such ratios are first reduced to single-dimensional, or scalar, values.

Once reduced, or converted, to scalars, percentage of change can be determined for each scalar. Percentage of change for scalars is determined by dividing a change in the scalar by an aggregate change in the metric. Using the example in Table 1, the percentage of change for the US is calculated as $100 (the change from $800 to $900) divided by $200 (the aggregate, or overall, change from $1,000 to $1,200).

In the exemplary embodiment, each ratio metric has two or more components that are mutually exclusive and collectively exhaustive. Components may be dimensions like countries or other metrics like CPC. Components are not necessarily used to calculate the ratio metric (i.e., dimensions, like the country of a web user). Analysis engine 210 facilitates identifying the percentage of change of each component. Alternatively, the components may not be mutually exclusive or collectively exhaustive, in which case the combined contributions of each component may not equal the aggregate change of the metric.

In one embodiment, known as the cross product method, analysis engine 210 identifies percentage of change by calculating the cross product of vectors related to observed two-dimensional metrics. Using RPM as an example, rather than treating RPM as a scalar value representing revenue per thousand queries at one point in time, e.g., t0, and comparing to another point in time, e.g., t1, RPM is treated as a vector in a plane with the y-axis representing revenue and the x-axis representing queries. The RPM vector, RPM0, extends from a starting point (0,0) to an end point (total revenue, total queries) at t0. A second vector, RPM1, extends from (0,0) to (total revenue, total queries) at t1. The total revenue and total query numbers may not be scaled down to the thousand, as scalar RPM commonly is. Times t0 and t1 may be ranges of time and/or days. For example, RPM0 could be the RPM for a week, and RPM1 could be the RPM for the following week.

The change from RPM0 to RPM1 is usually presented as just RPM1-RPM0 and would be scalar if the values RPM1 and RPM0 were scalar. Because RPM1 and RPM0 are vectors, the difference between RPM0 and RPM1 is also a vector. The part of the (RPM1-RPM0) vector that leads to RPM1 at t1 is the vector that is perpendicular to the direction of RPM0. This is similar to torque calculations in physics.

Thus, the net “torque” required to move from RPM0 to RPM1 is the cross product of RPM0 and RPM1. Also, if there are, for example, three mutually exclusive and collectively exhaustive ways to segment RPM, e.g., by geographic region, then the sum of torques calculated from the changes to each of the regions and applied to the overall RPM0 will be the overall torque calculated by the net torque that moved RPM0 to RPM1. For example, if RPM0_US, RPM0_EMEA, RPM0_ROW describe the RPM of the United States, the RPM of Europe, Middle East and Africa, and the RPM of the Rest of the World, respectively, at t0 and sum to RPM0, and similar vectors exist for t1 and sum to RPM1, then the torque that is described by each component's change equals the net torque on RPM0:

$$( RPM1\_US - PRM0\_US ) \times RPM 0 + ( RPM1\_EMEA - RPM0\_EMEA ) \times RPM 0 + ( RPM1\_ROW + RPM0\_ROW ) \times RPM 0 = RPM1\_US \times RPM 0 - RPM0\_US \times RPM 0 + RPM1\_EMEA \times RPM 0 - RPM0\_EMEA \times RPM 0 + RPM1\_ROW \times RPM 0 - RPM0\_ROW \times RPM 0 = RPM1\_US \times RPM 0 + RPM1\_EMEA \times RPM 0 + RPM1\_ROW \times RPM 0 - ( RPM0\_US + RPM0\_EMEA + RPM0\_ROW ) \times RPM 0 = ( RPM1\_US + RPM1\_EMEA + RPM1\_ROW ) \times RPM 0 - RPM 0 \times RPM 0 = RPM 1 \times RPM 0 \qquad Eq . 1$$

As the net torque can be described as a linear combination of the torque of components, each component's change contribution can thus be identified. Accordingly, a two-dimensional space has been reduced to a one-dimensional space, and the percentage of change for each component in a two-dimensional metric can be calculated in the same manner as a one-dimensional metric.

In another embodiment, known as the projection method, analysis engine 210 identifies percentage of change by projecting component vectors of two-dimensional ratios onto an axis. Using RPM as an example, the numerator (revenue, or R) is placed on the Y axis and the denominator (queries, or Q) on the X axis. Initial RPM (i.e., RPM at time 1, or RPM1) is equal to the slope of a line from (0,0) to a point (Q1, R1), as the slope is calculated as (R1−0)/(Q1−0). The point (Q1, R1) can be reached by compositing each component vector of RPM1 together. Final RPM (i.e., RPM at time 2, or RPM2) is equal to the slope of a line from (0,0) to a point (Q2, R2), as the slope is calculated as (R2−0)/(Q2−0). Similarly, the point (Q2, R2) can be reached by compositing each component vector of RPM2 together.

The individual contribution, or percentage of change, of each component to the change from RPM1 to RPM2 can be identified by determining how much each component contributed to the change in slope from RPM1 to RPM2. A difference or component vector is defined as the vector between (R2(d), Q2(d)) and (R1(d), Q1(d)), where d is a dimension or a metric. The component vectors are reduced to single-dimensional space by creating a new one-dimensional axis space where the axis is perpendicular to RPM1 and by projecting all the component vectors onto the new axis. The single-dimensional component vectors, or projected_x(d), may be calculated as shown in Eq. 2.

$$projected\_x ( d ) = cos ( arctan ( slope ( d ) ) - x\_axis ) * magnitude * sign \\ slope ( d ) = ( R 2 ( d ) - R 1 ( d ) ) / ( Q 2 ( d ) - Q 1 ( d ) ) \\ x\_axis = arctan ( - Q 1 / R 1 ) \\ magnitude = \sqrt{{( R 2 ( d ) - R 1 ( d ) )}^{2} + {( Q 2 ( d ) - Q 1 ( d ) )}^{2}} \\ sign = if Q 2 ( d ) < Q 1 ( d ) then - 1 ; else 1 \qquad Eq . 2$$

In other words, the component delta vectors can be projected onto a line perpendicular to the original RPM slope. The line is the one-dimensional space over which the percentage of change can be calculated (i.e., the line represents the aggregate change). More particularly, the length of each line segment can be used to identify the percentage of change for the component that that segment represents.

In another embodiment, known as the log method, analysis engine 210 identifies percentage of change by comparing the logarithms of each component. For example, if RPM is expressed as three ratios multiplied together, then the logs of each ratio, or component, can be summed to get the log of RPM. The three ratios may be CPC, CTR, and coverage. More particularly, the log of the change of each component can be summed to get the log of the change of RPM over a time period. The logs of each change are then analyzed as scalar values to determine the percentage contribution of each component.

Presentation engine 215 receives analysis data from analysis engine 210 and generates a visual representation of the analyzed data. More particularly, presentation engine 215 may receive raw numbers, percentage changes, and/or percentages of change for the metric being analyzed and/or components of the metric. Presentation engine 215 may generate tables, graphs, charts, listings, interactive displays, etc. as visual representations. In the exemplary embodiment, presentation engine 215 communicates the visual representations to client 103 as a web page or portions of a web page. Alternatively, presentation engine 215 may deliver the visual representations to client 103 via email, command line interface, API, and/or any method that communicates the visual representations to client 103. Presentation engine 215 and/or analysis engine 210 may generate a list of components that is ordered by corresponding percentage of change. Presentation engine 215 may present the raw data received from analysis engine 210.

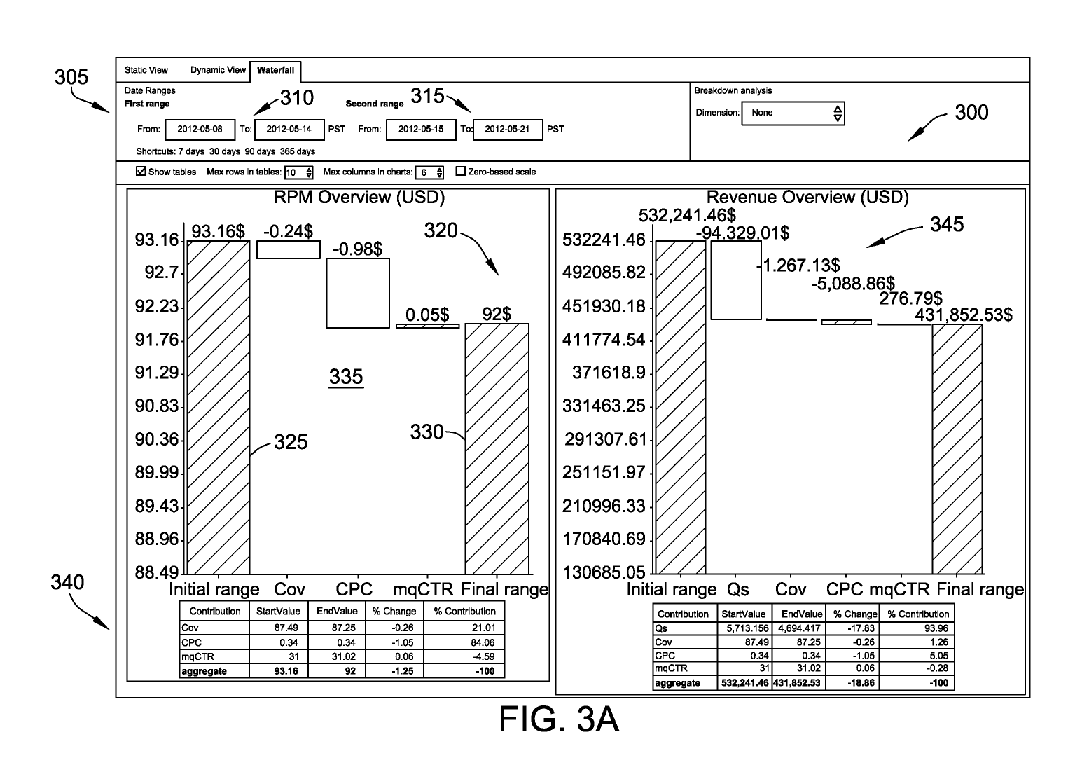

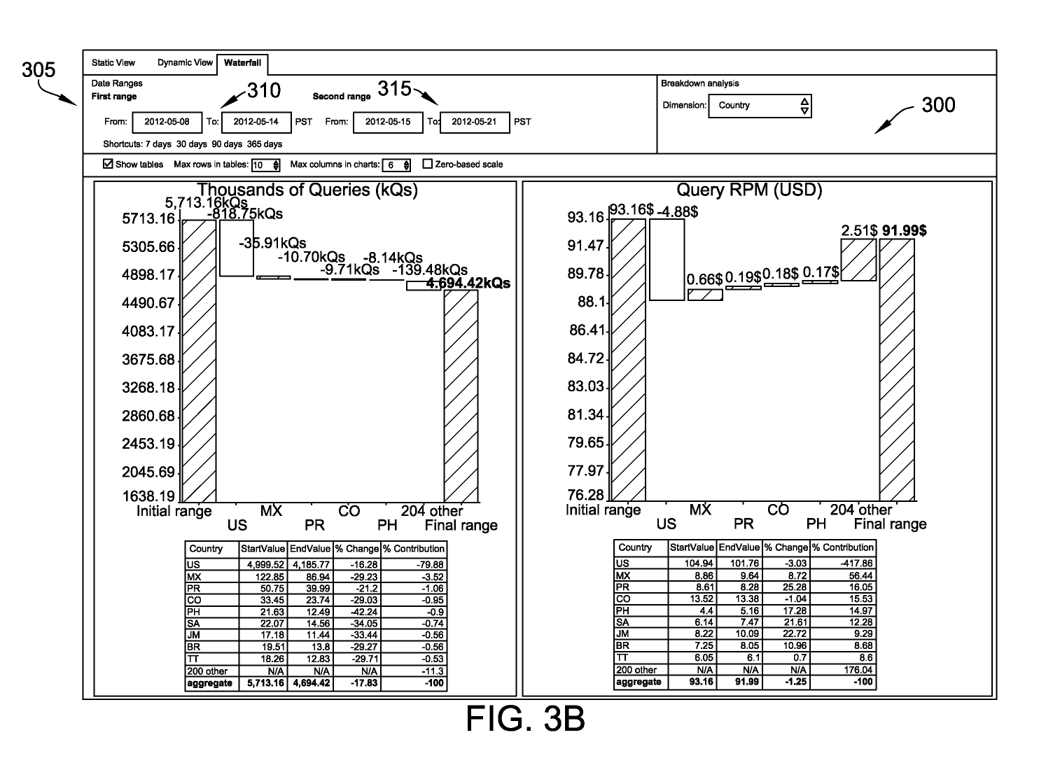

Presentation engine 215 may display the visual representations as part of a dashboard for conducting analysis on data in ad metric datastore 118. FIG. 3A is a screenshot of an exemplary dashboard 300 for use with analysis system 200. FIG. 3B is an alternative screenshot of the exemplary dashboard 300 illustrating different metrics and components. Dashboard 300 includes a selection area 305 where a user can select the data to be displayed and customize how the data is displayed. A selectable first date range 310 is compared with a selectable second date range 315. A first graph 320 is a waterfall graph showing a comparison of RPM of the first date range 310 with the second date range 315. An initial RPM 325 (i.e., the RPM for the first date range 310) and a final RPM 330 (i.e., the RPM for the second date range 315) are shown. One or more components 335 that contribute to RPM are shown.

In the example shown in first graph 320, the one or more components include coverage, CPC, and CTR. As shown, RPM fell from the first date range 310 to the second date range 315. The vertical height of each component 335 in first graph 320 represents the percentage contribution, or percentage of change. For example, as shown in a first table 340, coverage contributed 21.01% to the drop in RPM. The 21.01% contribution from coverage is shown in first graph 320 as 21.01% of the vertical distance between initial RPM 325 and final RPM 330. Likewise, the 84.06% contribution of CPC and the −4.59% contribution of CTR are shown. Because CTR had an opposite effect on the overall RPM change (i.e., it was positive when the overall change was negative), its contribution is negative and is shown as rising in first chart 320. Raw values and/or percentage changes may be shown with each component 335. Colors may be used to indicate whether components 335 had a positive or negative percentage change. For example, coverage and CPC may be shown as red, and CTR may be shown as green in first graph 320.

A second graph 345 is similar to first graph 320, except second graph 345 shows revenue, a scalar value, comprised of a mix of one and two-dimensional metrics. Second graph 345 adds a scalar value for number of queries. A user would see that CPC contributed most to the decline in RPM between the selected time periods, and that a decline in queries contributed to an overall loss in revenue for the same time period. To further analyze the data, a user could select, using a dimension selector 350, a dimension for analysis.

Although FIGS. 3A and 3B show the percentage contributions summing to 100%, it should be appreciated that not all components may be shown, in which case the percentage contributions may not sum to 100%. Moreover, the components may not be mutually exclusive and collectively exhaustive, in which case the components may show a combined contribution that is greater or less than 100%. When using the log method, the percentage contributions for all components may not sum to 100%. In such a case, and in other circumstances where the displayed percentage contributions do not sum to 100%, a gap-filling component may be displayed that does not necessarily correspond to any component or metric, but does cause the percentage contributions sum to 100%. When a large number of dimensions are to be shown, the presentation engine 215 may elect to combine smaller dimensions into a consolidated “other” dimension, such as the example in FIG. 3B. The graphs in FIG. 3B show the top five components and an aggregation of the remaining components.

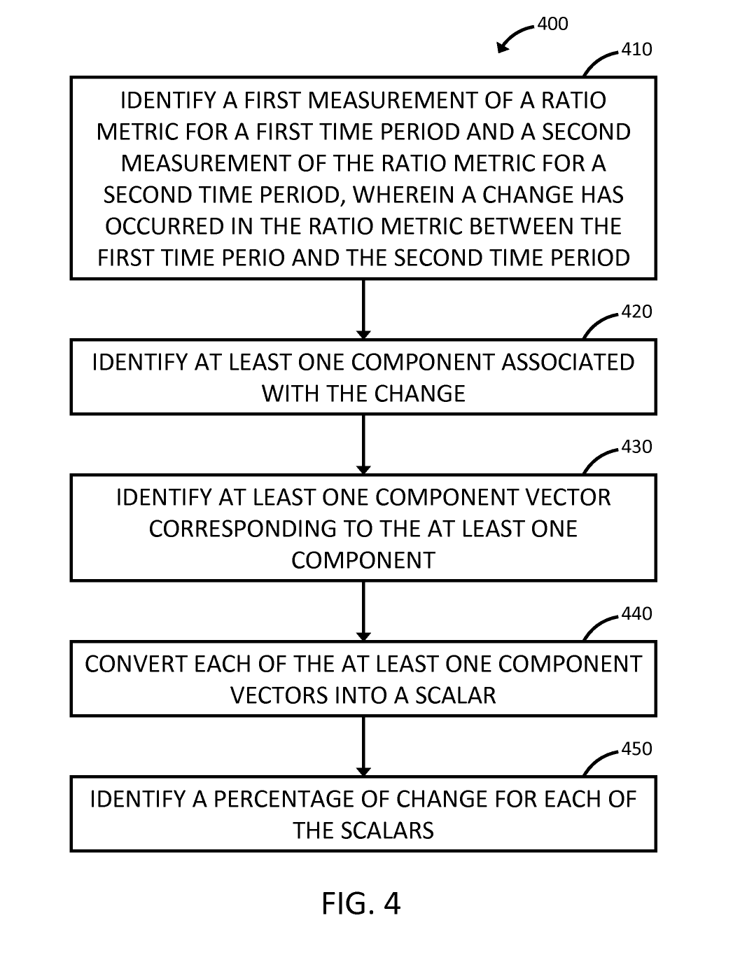

FIG. 4 is a flow chart of an exemplary method 400 for analyzing ratio metrics. Method 400 includes steps that can be implemented as instructions and executed by one or more processors in one or more computer systems. In some implementations, method 400 can be performed by client 103, server 109, and/or analysis system 200.

A first measurement of a metric for a first time period and a second measurement of the metric for a second time period are identified 410. The first and second periods may have durations that are instants, seconds, hours, days, weeks, etc. A change has occurred in the metric between the first time period and the second time period.

At least one component associated with the change is identified 420. At least one component may be a ratio or a scalar (i.e., a dimension or a one-dimensional metric). For example, if the metric is RPM, then at least one component may include CPC and/or CTR. At least one component may be identified 420 by user selection, by detecting components that contributed to the change, by definition, by template, and/or by any process that enables method 400 to function as described herein. At least one component vector is identified 430 that corresponds to at least one component. As explained in more detail herein, each component vector, in the case of mutually exclusive and collectively exhaustive components, can be composited to connect an endpoint of an initial metric vector to an endpoint of a final metric vector.

Each of at least one component vectors is converted 440 into a scalar. The component vectors may be converted 440 into a scalar using, e.g., the cross product or projection methods. By converting 440 each component vector to a scalar, the problem is reduced from multiple dimensions to a single dimension. A percentage of change for each of the scalars can then be identified 450 as described herein. After identifying the percent of change, or percentage contribution, the first measurement, second measurement, and each scalar can be depicted in a visual representation, such as a waterfall graph.

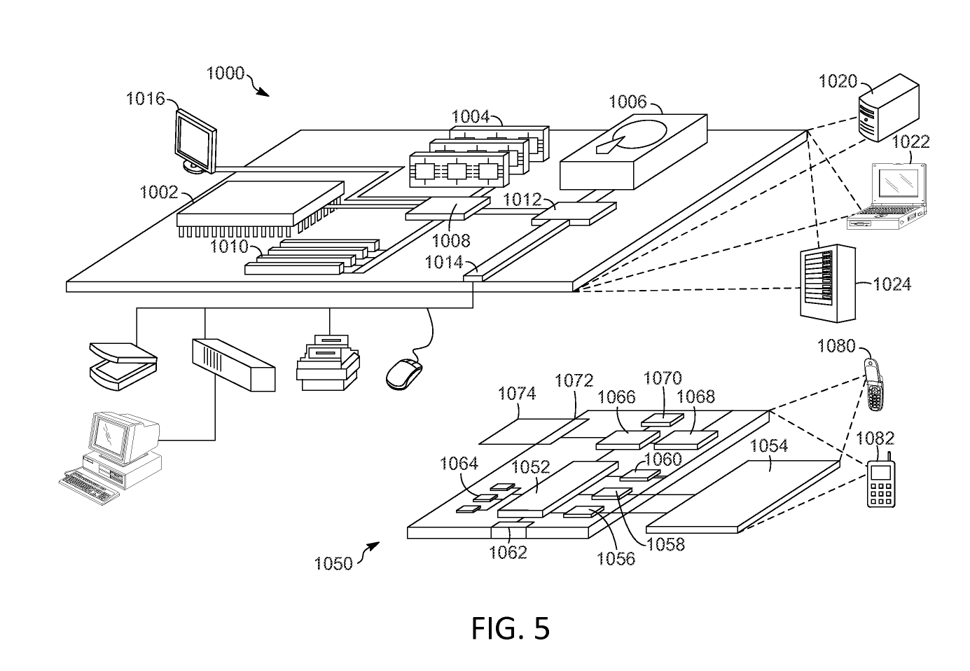

FIG. 5 is a block diagram showing example or representative computing devices and associated elements that may be used to implement the systems of FIGS. 1 and 2. FIG. 5 shows an example of a generic computing device 1000 and a generic mobile computing device 1050, which may be used with the techniques described here. Computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1000 includes a processor 1002, memory 1004, a storage device 1006, a high-speed interface or controller 1008 connecting to memory 1004 and high-speed expansion ports 1010, and a low-speed interface or controller 1012 connecting to low-speed bus 1014 and storage device 1006. Each of the components 1002, 1004, 1006, 1008, 1010, and 1012, are interconnected using various busses, and may be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as display 1016 coupled to high-speed controller 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a volatile memory unit or units. In another implementation, the memory 1004 is a non-volatile memory unit or units. The memory 1004 may also be another form of computer-readable medium, such as a magnetic or optical disk.

The storage device 1006 is capable of providing mass storage for the computing device 1000. In one implementation, the storage device 1006 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of functions is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed bus 1014. The low-speed bus 1014, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can execute instructions within the computing device 1050, including instructions stored in the memory 1064. The processor may be implemented as a chipset of chips that include separate and multiple analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD (Thin-Film-Transistor Liquid Crystal Display) or an OLED (Organic Light Emitting Diode) display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provide in communication with processor 1052, so as to enable near area communication of device 1050 with other devices. External interface 1062 may provide, for example, for wired communication in some implementations, or for wireless communication in other implementations, and multiple interfaces may also be used.

The memory 1064 stores information within the computing device 1050. The memory 1064 can be implemented as one or more of a computer-readable medium or media, a volatile memory unit or units, or a non-volatile memory unit or units. Expansion memory 1074 may also be provided and connected to device 1050 through expansion interface 1072, which may include, for example, a SIMM (Single In Line Memory Module) card interface. Such expansion memory 1074 may provide extra storage space for device 1050, or may also store applications or other information for device 550. Specifically, expansion memory 1074 may include instructions to carry out or supplement the processes described above, and may include secure information also. Thus, for example, expansion memory 1074 may be provide as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1064, expansion memory 1074, or memory on processor 1052, that may be received, for example, over transceiver 1068 or external interface 1062.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, Wife, or other such transceiver (not shown). In addition, GPS (Global Positioning system) receiver module 1070 may provide additional navigation- and location-related wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smart phone 1082, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., computing device 1000 and/or 1050) that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing devices 1000 and 1050 are configured to receive and/or retrieve electronic documents from various other computing devices connected to computing devices 1000 and 1050 through a communication network, and store these electronic documents within at least one of memory 1004, storage device 1006, and memory 1064. Computing devices 1000 and 1050 are further configured to manage and organize these electronic documents within at least one of memory 1004, storage device 1006, and memory 1064 using the techniques described herein.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included. For example, while advertising metrics have been used throughout, these are merely meant as examples, and other two-dimensional measurements or metrics from other fields of endeavor may also be used with the methods and systems described herein.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “identifying” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the invention may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for analyzing changes in aggregate ratio metrics using a computer device coupled to a memory device, the method comprising:
storing a plurality of metrics in the memory device;
identifying a first measurement of a ratio metric for a first time period and a second measurement of the ratio metric for a second time period from the plurality of metrics stored in the memory device, wherein a change has occurred in the ratio metric between the first time period and the second time period;
identifying at least one component associated with the change;
determining, using the computer device, at least one component vector in two-dimensional space corresponding to the at least one component;
using the computer device to convert each of the at least one component vectors into a scalar; and
identifying a percentage of change for each of the scalars.

2. The computer-implemented method of claim 1, further comprising generating a visual representation of the percentage of change for each of the scalars.

3. The computer-implemented method of claim 2, wherein generating a visual representation comprises generating a waterfall graph.

4. The computer-implemented method of claim 1, wherein converting each of the at least one component vectors into a scalar comprises determining a cross product of the at least one component vector and a vector corresponding to the first measurement.

5. The computer-implemented method of claim 1, wherein converting each of the at least one component vectors into a scalar comprises projecting each component vector onto a one-dimensional axis that is perpendicular to a vector corresponding to the first measurement.

6. The computer-implemented method of claim 1, further comprising generating a list of components that is ordered by corresponding percentage of change.

7. The computer-implemented method of claim 1, wherein identifying a first measurement of a metric comprises identifying a first measurement of a ratio metric, wherein the ratio metric includes one of revenue per mille, cost per click, click through rate, and coverage.

8. The computer-implemented method of claim 1, wherein identifying at least one component associated with the change comprises identifying at least one component related to country, language, and channel.

9. A computer program product tangibly embodied in a non-transitory computer-readable storage device and comprising instructions that, when executed by a processor, cause the processor to:
identify a first measurement of a ratio metric for a first time period and a second measurement of the ratio metric for a second time period from a plurality of metrics stored in a memory device, wherein a change has occurred in the ratio metric between the first time period and the second time period;
identify at least one component associated with the change;
determine at least one component vector in two-dimensional space corresponding to the at least one component;
convert each of the at least one component vectors into a scalar; and
identify a percentage of change for each of the scalars.

10. The computer program product of claim 9, further comprising instructions that when executed cause the processor to generate a visual representation of the percentage of change for each of the scalars.

11. The computer program product of claim 10, wherein generating a visual representation comprises generating a waterfall graph.

12. The computer program product of claim 9, wherein converting each of the at least one component vectors into a scalar comprises determining a cross product of the at least one component vector and a vector corresponding to the first measurement.

13. The computer program product of claim 9, wherein converting each of the at least one component vectors into a scalar comprises projecting each component vector onto a one-dimensional axis that is perpendicular to a vector corresponding to the first measurement.

14. The computer program product of claim 9, further comprising instructions that when executed cause the processor to generate a list of components that is ordered by corresponding percentage of change.

15. The computer program product of claim 9, wherein identifying a first measurement of a metric comprises identifying a first measurement of one of revenue per mille, cost per click, click through rate, and coverage.

16. The computer program product of claim 9, wherein identifying at least one component associated with the change comprises identifying at least one component related to country, language, and channel.

17. A computer system including instructions stored on a non-transitory computer-readable medium and executable by at least one processor, the computer system comprising:
a data retrieval engine for retrieving metric data from an ad metric datastore; and
an analysis engine for:
identifying, using metric data from said data retrieval engine, a first measurement of a ratio metric for a first time period and a second measurement of the ratio metric for a second time period, wherein a change has occurred in the ratio metric between the first time period and the second time period;
identifying at least one component associated with the change;
determining at least one component vector in two-dimensional space corresponding to the at least one component;
converting each of the at least one component vectors into a scalar; and
identifying a percentage of change for each of the scalars.

18. The computer system of claim 17, wherein converting each of the at least one component vectors into a scalar comprises determining a cross product of the at least one component vector and a vector corresponding to the first measurement.

19. The computer system of claim 17, wherein converting each of the at least one component vectors into a scalar comprises projecting each component vector onto a one-dimensional axis that is perpendicular to a vector corresponding to the first measurement.

20. The computer system of claim 17, wherein the computer system further comprises a presentation engine for generating a visual representation of the percentage of change for each of the scalars.
